(19) United States
(12) Patent Application Publication
(10) Pub. No.: US 2026/0072667 A1
(43) Pub. Date: Mar. 12, 2026

(54) Method and Device for Sharing Services Between a Vehicle and a Trailer

(71) Applicants: Hyundai Motor Company, Seoul (KR); Kia Corporation, Seoul (KR)

(72) Inventors: Myeong Gwan Kim, Hwaseong-Si (KR); Ui Jung Jung, Hwaseong-si (KR)

(21) Appl. No.: 19/041,329

(22) Filed: Jan. 30, 2025

(30) Foreign Application Priority Data
Sep. 12, 2024 (KR) 10-2024-0124691

(51) Int. Cl. G06F 8/61; B60D 1/62; G07C 5/00

(52) U.S. Cl. CPC G06F 8/62; B60D 1/62; G07C 5/008

(57) ABSTRACT

Disclosed is a method for sharing a service between a vehicle and a trailer, which is performed by the vehicle. The method may include: establishing a communication channel between the vehicle and a trailer; receiving, from the trailer via the communication channel, trailer information of the trailer; transmitting, to a server, vehicle information of the vehicle and the trailer information; receiving, from the server, vehicle software and trailer software, wherein the vehicle software and the trailer software are selected by the server; transmitting, to the trailer via the communication channel, the trailer software; and controlling, based on the vehicle software, a driving operation of the vehicle.

### CROSS REFERENCE TO RELATED APPLICATION

The present application claims priority to a Korean application No. 10-2024-0124691, filed on Sep. 12, 2024, the entire contents of which are incorporated herein by reference for all purposes.

### TECHNICAL FIELD

The present disclosure relates to a method and device for a vehicle service, and more particularly, to a method and device for sharing a service between a vehicle and a trailer.

### BACKGROUND

Over the years in the commercial trailer industry, commercial vehicles have been equipped with an increasing variety of functions to fulfill the needs of various situations and use cases. Many trailer manufacturers, both domestic and foreign, have designed and built vehicles and trailers (e.g., semi-trailers) to suit the requirements of trailer operators and the trucking industry in general.

However, various specifications for trailers have not been set up or standardized yet, and there is no full-fledged specification for every individual vehicle-trailer combination.

Thus, in the trailer industry today that uses commercial vehicles, a trailer company that receives a customer request for customization to meet various demands, may ask an original equipment manufacturer (OEM) to custom-build a vehicle and a trailer that fit the design requirements. The OEM may build and deliver the vehicle and the trailer after customizing and modifying the functions of the vehicle and the trailer according to the request of the trailer company, and the trailer company may deliver the final products to the customer.

Accordingly, the OEM may have little choice but to make physical modifications to its vehicle and trailer by faithfully adhering to the requirements demanded by the trailer company.

### SUMMARY

The present disclosure is technically directed to providing a method and device for efficiently sharing a service between a vehicle and a trailer through a communication link between the vehicle and the trailer.

In addition, to solve a technical problem of the present disclosure, a system consisting of a vehicle, a trailer and a server may be provided to implement a method and device for sharing a service conforming to a customer's demand.

The technical problems solved by the present disclosure are not limited to the above technical problems and other technical problems which are not described herein will be clearly understood by a person having ordinary skill in the technical field, to which the present disclosure belongs, from the following description.

According to one or more example embodiments of the present disclosure, a method for sharing a service between a vehicle and a trailer, which is performed by the vehicle may include: connecting to the trailer for communication, obtaining trailer information from the trailer, transmitting vehicle information and the obtained trailer information to a server, receiving as a response to the transmitted vehicle information and the transmitted trailer information, selected vehicle software and selected trailer software from the server and transmitting the trailer software to the trailer.

The method may further include: after the transmitting of the trailer software to the trailer, receiving a result of a trailer software test performed in the trailer; and deleting, based on the result of the trailer software test, the trailer software.

Deleting the trailer software may include: deleting the trailer software in one of a manual deletion mode or an automatic deletion mode.

The method may further include: in the manual deletion mode, outputting, via an audio video navigation (AVN), a stored software list; and deleting the trailer software according to a user input indicating an order of deletion.

The method may further include: in the automatic deletion mode, deleting the trailer software based on at least one of: whether the trailer software is developed at least by an unverified entity, whether a validity period of the trailer software expires within a threshold time duration, whether the trailer software has never been used by the trailer, or whether the trailer software is monitoring a status of the vehicle and the trailer.

According to one or more example embodiments of the present disclosure, a method for sharing a service between a vehicle and a trailer, which is performed by trailer may include: connecting to the vehicle for communication; transmitting trailer information to the vehicle; and receiving trailer software from the vehicle, wherein the received trailer software corresponds to trailer software selected by the server based on vehicle information transmitted by the vehicle to the server and the trailer information.

The method may further include: after the receiving of the trailer software from the vehicle, performing a software test for the trailer software; and transmitting, to a vehicle controller of the vehicle, a result of the software test.

Performing the software test comprises: determining whether the trailer software operates normally by comparing the trailer software with a test case generated through a software service interface, wherein the software service interface is transmitted from the server.

The method may further include: deleting, based on the result of the software test, the trailer software in one of a manual deletion mode or an automatic deletion mode.

The method may further include: in the manual deletion mode, outputting, via an audio video navigation (AVN), a stored software list; and deleting the trailer software according to a user input indicating an order of deletion.

The method may further include: in the automatic deletion mode, deleting the trailer software based on at least one of: whether the trailer software is developed at least by an unverified entity, whether a validity period of the trailer software expires within a threshold time duration, whether the trailer software has never been used by the trailer, or whether the trailer software is monitoring a status of the vehicle and the trailer.

According to one or more example embodiments of the present disclosure, a method for sharing a service between a vehicle and a trailer which is performed by a server may include: receiving, receiving vehicle information from the vehicle and trailer information obtained from the trailer; selecting vehicle software and trailer software based on the vehicle information and the trailer information; adding trailer data to the selected vehicle software; and transmitting the selected vehicle software and the selected trailer software to the vehicle.

The method may further include transmitting a software service interface for a trailer software test, wherein the trailer software test is configured to be performed in the trailer.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 shows a schematic diagram illustrating a vehicle, a trailer and a server that perform wired and wireless communication and have a service sharing device.

FIG. 2 shows the internal structures of a vehicle and a trailer.

FIG. 3 shows a constituent modules of a vehicle and a trailer.

FIG. 4A and FIG. 4B show flowcharts of a method for sharing a service between a vehicle and a trailer.

FIG. 5 shows a detailed flowchart of a method for sharing a service between a vehicle and a trailer, which is implemented in the vehicle.

FIG. 6 shows a detailed flowchart of a method for sharing a service between a vehicle and a trailer, which is implemented in the trailer.

FIG. 7 shows a detailed flowchart of a method for sharing a service between a vehicle and a trailer, which is implemented in a server.

FIG. 8 shows a view showing an overall configuration of a server, a vehicle and a trailer.

FIG. 9 shows an internal operation process in a vehicle and a trailer.

FIG. 10 shows an electronic control unit structure in a vehicle and a trailer and various functions provided by a controller.

FIG. 11 shows a flowchart showing a process of deleting software operating in memories of a vehicle controller and a trailer controller.

FIG. 12 shows a communication process between a vehicle and a trailer including an internal structure of a trailer controller performing a software test.

FIG. 13 shows a detailed process of operating a software test by internal modules of a trailer controller.

FIG. 14 shows a flowchart showing a process of a software test performed in a trailer controller.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains. The present disclosure describes a method for a vehicle and a trailer to efficiently share a service by receiving software conforming to a customer's demand.

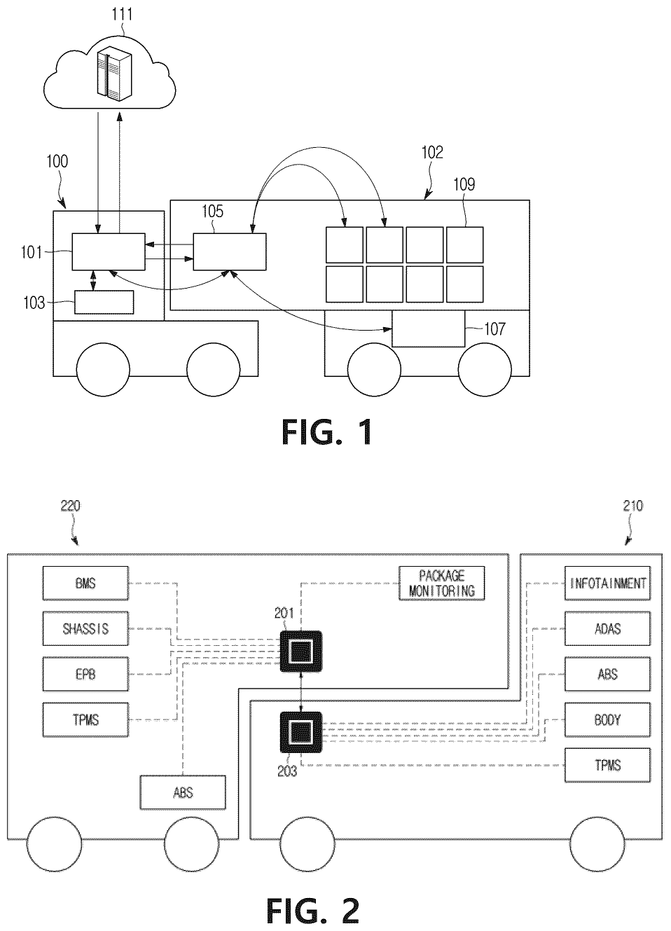

Hereinafter, a service sharing device via wired and wireless communication between a vehicle and a trailer will be described with reference to FIG. 1.

FIG. 1 a schematic diagram illustrating a vehicle, a trailer and a server that perform wired and wireless communication and have a service share device.

As for each of the components, first, a vehicle 100 is a device that relays communication between a server 111 and a trailer 102, and the vehicle and the server or the vehicle and the trailer may communicate each other in various manners. The vehicle 100 may include a controller 101 and a controller 103, and the trailer 102 may include a controller 105 and a controller 107. In addition, the trailer 102 may be loaded with various goods 109. Herein, in the vehicle 100, an integrated vehicle controller including the controller 103 and the controller 101 according to the present disclosure may be configured. In addition, in the trailer 102, an integrated trailer controller including the controller 107 and the controller 103 according to the present disclosure may be configured. In this regard, a vehicle controller may mean the integrated vehicle controller or the controller 101 according to the present disclosure, and a trailer controller may mean the integrated trailer controller or the controller 105 according to the present disclosure. Hereinafter, for convenience of explanation, the terms ‘vehicle controller’ and ‘trailer controller’ will be used.

A vehicle controller and a trailer controller may be connected using wired/wireless communication, perform an interface function, and control the controllers.

The vehicle controller and the trailer controller may control and manipulate various systems between a vehicle and a trailer and download or share software for exchanging data or performing a service via connection.

The vehicle and the trailer may assume a physical connection and be connected via wired/wireless communication based on the physical connection. One vehicle and a plurality of trailers may be connected to each other at different times. That is, even when different purposes are demanded for each vehicle and each trailer, based on vehicle information and trailer information obtained from a trailer, a server may transmit suitable vehicle software and trailer software to perform a service.

A vehicle may be implemented as an autonomous vehicle and carry a trailer between hubs. For example, the vehicle may be a tractor that is a type of vehicle performing a specific function. In addition, the trailer may include a cargo hold that is a means of carrying freight or goods.

FIG. 2 is a view showing the internal structures of a vehicle 210 and a trailer 220. Referring to FIG. 2, a method for sharing a service between a vehicle and a trailer according to the present disclosure may have comprehensive understanding about communication between a vehicle controller 203 and a trailer controller 201 and communication between the vehicle controller and multiple controllers of the trailer controller.

Specifically, each of the vehicle controller 203 and the trailer controller 201 may exchange or share software for performing various functions. A vehicle controller may have wired/wireless communication with a server, receive software from the server via communication and store the software in a memory of the vehicle controller.

The vehicle controller 203 and the trailer controller 201 may exchange information and stored software via communication, and each of the controllers may extract and use suitable information for a necessary service.

In addition, when a vehicle and a trailer require software, the software may be separately updated for each service. A vehicle controller and a trailer controller may be installed in a vehicle and a trailer respectively, and thus separately updated software may be controlled and operated. Various software may be provided from an outside region to a trailer through a vehicle controller and a trailer controller, and it is possible to use software capable of providing various services by reflecting users' demands.

This may be a structure in which software performing functions of a vehicle and a trailer are stored in memories of a vehicle controller and a trailer controller and become services, and thus the vehicle controller and the trailer controller give and take necessary information via bidirectional communication between the vehicle and the trailer.

A vehicle controller may control one or more functions by being connected to controllers via wired/wireless communication. For example, the functions of a vehicle may include infotainment corresponding to a vehicle information and entertainment system, advanced driver assistance systems (ADAS) for assisting a driver, an anti-lock braking system (ABS), which is a system for preventing the braking effect, BODY, which is a concept encompassing a car body that is the main structural part of a car, internal and external panels, doors and windows, and a tire pressure monitoring system (TMPS) for monitoring air pressure of tire.

In addition, like the vehicle controller, a trailer controller may also control the functions of a trailer by being connected with the functions. For example, the functions of a trailer may include a battery management system (BMS), chassis, an electronic parking brake (EPB), a TPMS, and an ABS.

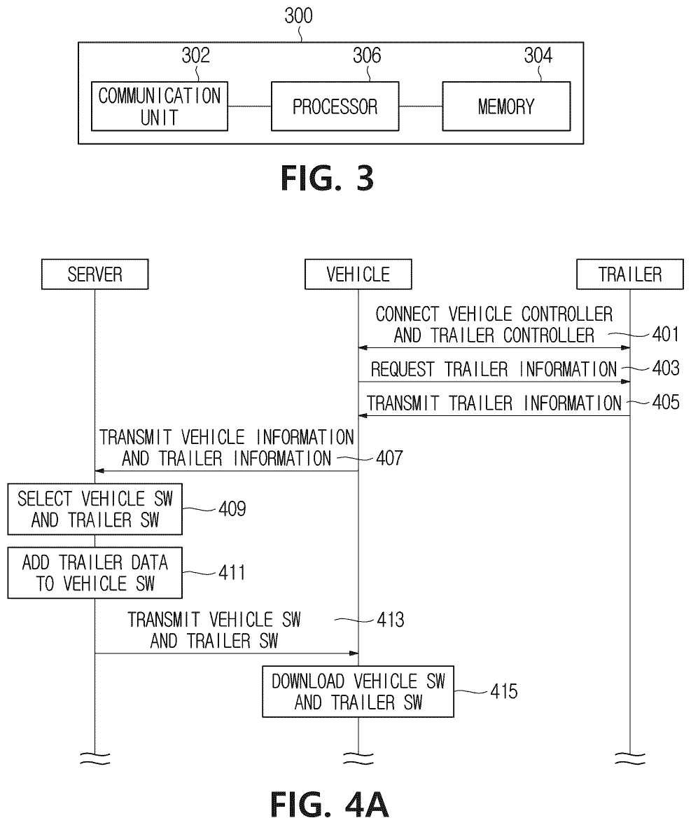

FIG. 3 is a view showing a general module 300 constituting a server, a vehicle or a trailer.

The server, the vehicle and the trailer may commonly include a communication unit 302, a processor 305 and a memory 304. The communication unit 302 may be a communication module that is used to exchange information with a vehicle, a trailer or a server. The communication unit may use wired/wireless communication (e.g., establish a wired or wireless communication channel). For example, wireless communication, such as Bluetooth and Wi-Fi, may be mainly used between a vehicle controller and a trailer controller, and wired/wireless communication such as CAN, LIN and Ethernet may be used between the trailer controller and a controller in a trailer. However, this is merely one example, and another type of wired/wireless communication may be used.

The memory may receive and store at least one or more pieces of software for providing various functions in a vehicle and a trailer. For example, the processor may mean a comprehensive processor including the vehicle controller and the trailer controller. In addition, the processor may be a device that implements an operation of the server.

Particularly, the vehicle controller and the trailer controller may exchange information between the vehicle and the trailer by being connected via wired/wireless communication, deliver various functions to be provided to a user, and provide a useful service. The vehicle controller may request trailer information to the trailer and receive information of the trailer. The vehicle controller may communicate with the server to transmit vehicle information and the obtained trailer information.

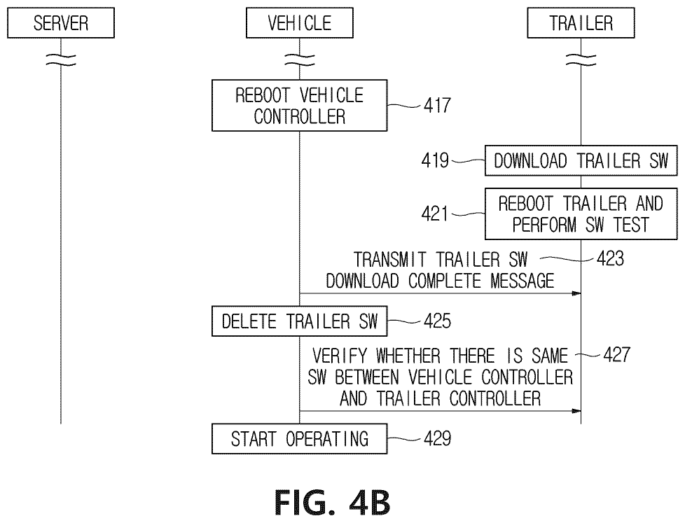

The above-described processing of the processor among the server, the vehicle and the trailer will be described in detail through FIG. 4A and FIG. 4B.

FIG. 4A and FIG. 4B are flowcharts of a method for sharing a service between a vehicle and a trailer.

Referring to FIG. 4A, in relation to a method for sharing a service between a vehicle and a trailer, an operation process among a server, the vehicle and the trailer may be known. First, the vehicle and the trailer may connect each controller via wired/wireless communication (401). Specifically, the controller may include various controllers in each of the vehicle and the trailer and also control the controllers. In this regard, step S401 may be performed after the vehicle and the trailer are physically combined with each other. That is, after physical combination, a vehicle controller and a trailer controller may be connected with each other via wired/wireless communication. At least in some embodiments, one vehicle may be coupled to one trailer, but as the vehicle controller and the trailer controller are connected via wired/wireless communication and share a service, one vehicle may be coupled to a plurality of trailers at different times.

Next, the vehicle may request trailer information to the trailer (403), and the trailer may transmit the trailer information requested from the vehicle (405). The vehicle may transmit vehicle information and the trailer information to the server (407).

The requesting of the trailer information (403) and the transmitting of the requested trailer information (405) may be performed in a predetermined format according to standardized information. For example, the trailer information may include a trailer number, a maximum load amount, an overload state, a vehicle speed, a battery state of charge (SOC), a current location, a departure point, and a destination. The vehicle information may include a vehicle number, a vehicle speed, a battery SOC, a current location, a departure point, and a destination.

Accordingly, the server may select vehicle software and trailer software applicable and available in the vehicle and the trailer based on the received information (409). For example, as for the selection at step S409, if the vehicle information and the trailer information are related to transport of goods, software for monitoring for preventing a package from being lost may be selected. If the vehicle information and the trailer information are related to firefighting, software for fire detection and fire suppression may be selected.

In this case, software stored in the database of the server may be selected by the server. In case there is no necessary software in the database of the server, software may be received from a third party outside the server.

Before the selected vehicle software and the selected trailer software, the server may add information on the trailer only to the vehicle software (411). Because the vehicle transmits the trailer software to the trailer after both the vehicle software and the trailer software are downloaded into the memory of the vehicle controller, the trailer information, which the trailer may request, may be added to the vehicle software. However, step S411 may be excluded. However, if step S411 is added, it may be expected that a service may be smoothly shared between the vehicle and the trailer by adding the trailer information to the vehicle software. For example, when the vehicle and the trailer are related to transport of goods, a service may be smoothly provided by providing information on the weight, type and size of goods beforehand.

In addition, the server may transmit the selected vehicle software and the selected trailer software to the vehicle first (413). The vehicle may duplex a memory to stabilize a system and download the trailer software as well as the vehicle software into the duplexed memory (415).

Referring to FIG. 4B, after the dynamic process of sharing a service among the server, the vehicle and the trailer in FIG. 4A, a process of efficiently managing the software downloaded from the vehicle controller and the trailer controller may be known.

First, FIG. 4B may be performed after the last step of FIG. 4A. That is, after the vehicle controller receives vehicle software and trailer software from the server, the vehicle controller may reboot them (417), and the vehicle software may be used in the vehicle. Herein, the rebooting by the vehicle controller means restarting a program or a part of a system, and in particular, if new software is downloaded, a corresponding program or service may be restarted. The rebooting of the vehicle controller according to step S417 may be omitted, and a different application may be possible according to a system.

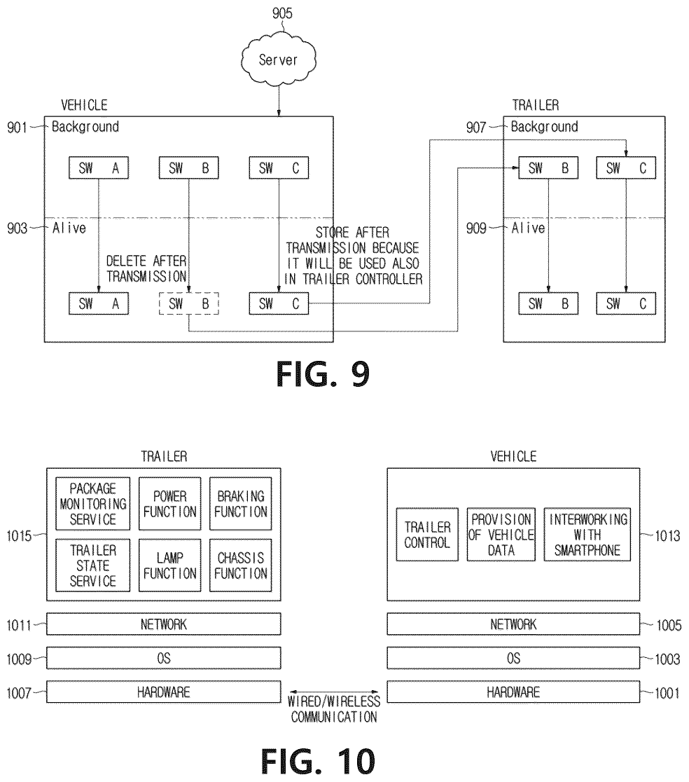

After the vehicle controller reboots, the vehicle may transmit the trailer software to the trailer controller. The trailer controller may completely download the received trailer software (419) and reboot it. After the trailer controller completely reboots the software, the trailer controller may perform a software test to see whether the software normally operates (421). The software test performed in the trailer controller will be described in detail through FIG. 9 to FIG. 11 below.

In addition, when the software test in the trailer controller has a normal result, the trailer controller may transmit a software download complete message to the vehicle controller (423), and the vehicle controller may delete a same area as the trailer software in the duplexed memory in order to optimize the memory through prevention of duplication (425).

In addition, it is possible to verify whether there is same software among software stored in the memory by using wired/wireless communication between the vehicle controller and the trailer controller (427). Next, the vehicle may start operating (429).

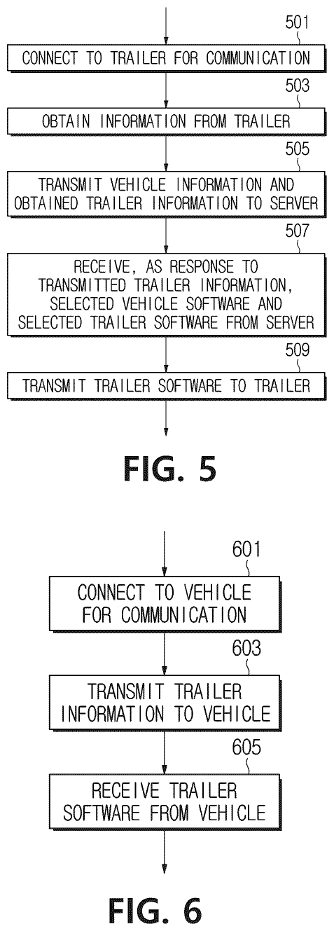

FIG. 5 is a detailed flowchart of a method for sharing a service between a vehicle and a trailer, which is implemented in the vehicle.

Referring to FIG. 5, a method for sharing a service between a vehicle and a trailer, which is implemented in the vehicle according to the present disclosure, may include connecting to the trailer for communication (501), obtaining information from the trailer (503), transmitting vehicle information and the obtained trailer information to a server (505), receiving, as a response to the transmitted trailer information, selected vehicle software and selected trailer software from the server (507), and transmitting the trailer software to the trailer (509).

First, according to step S501, the connecting to the trailer for communication (e.g., establishing a communication channel between the vehicle and the trailer) may be performed by using wired/wireless communication for a vehicle controller and a trailer controller. For example, wireless communication like Bluetooth and Wi-Fi may be used.

In addition, according to step S503, the obtaining of the information from the trailer may obtain the information at a request of the vehicle controller. As the trailer itself is not capable of transmitting the trailer information to the server, the information may be forwarded through the vehicle controller.

According to step S505, the vehicle may transmit the vehicle information and the obtained trailer information to the server.

FIG. 6 is a detailed flowchart of a method for sharing a service between a vehicle and a trailer, which is implemented in the trailer.

Referring to FIG. 6, a method for sharing a service between a vehicle and a trailer, which is implemented in the trailer according to the present disclosure, may include connecting to the vehicle for communication (601), transmitting trailer information to the vehicle (603), and receiving trailer software from the vehicle (605).

First, according to step S601, the connecting to the vehicle for communication may be performed by using wired/wireless communication for a vehicle controller and a trailer controller. Through connection between each integrated controller, vehicle information and the trailer information required in a server, the vehicle and the trailer may be requested and exchanged.

In addition, according to step S603, the transmitting of the trailer information to the vehicle may transmit the trailer information as required by the server or the vehicle from the trailer to the vehicle because the trailer is not capable of performing communication with the server.

According to step S605, like step S603, the receiving of the trailer software from the vehicle may receive the trailer software from the vehicle, which had been transmitted from the server, because the trailer is incapable of performing communication with the server. Herein, the received trailer software may correspond to trailer software selected by the server based on the vehicle information transmitted from the vehicle to the server and the trailer information.

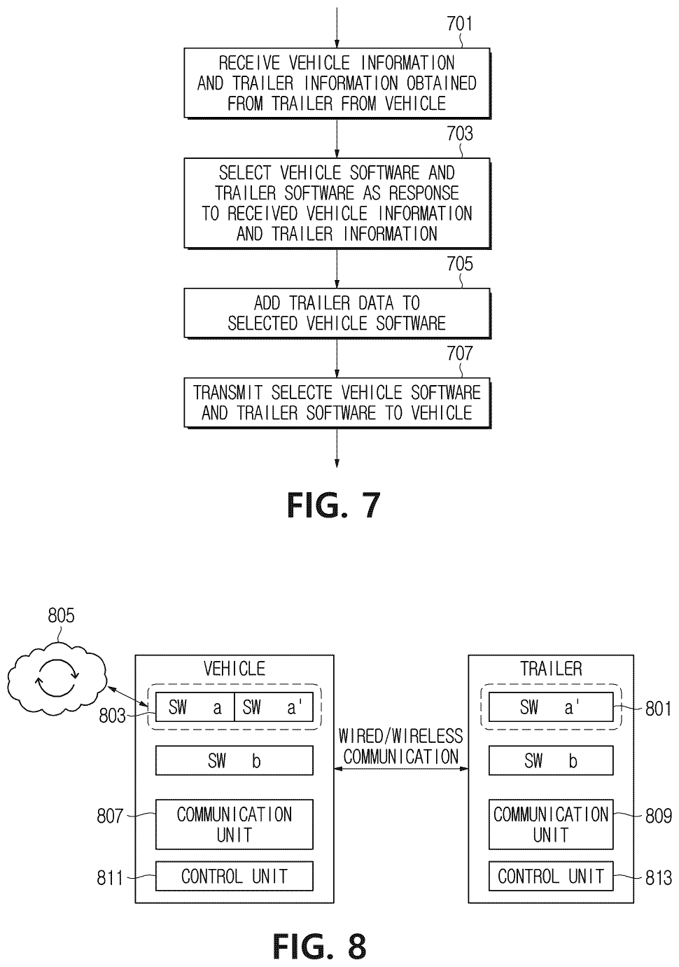

FIG. 7 is a detailed flowchart of a method for sharing a service between a vehicle and a trailer, which is implemented in a server.

Referring to FIG. 7, a method for sharing a service between a vehicle and a trailer, which is implemented in a server according to the present disclosure, may include receiving vehicle information from the vehicle and trailer information from the trailer (701), selecting, as a response to the received vehicle information and the received trailer information, vehicle software and trailer software (703), adding trailer data to the selected vehicle software (705), and transmitting the selected vehicle software and the selected software to the vehicle (707).

First, according to step S701, the receiving of the vehicle information from the vehicle and the trailer information from the trailer may be required for the server to select and transmit software equipped with a function executable in the vehicle and the trailer based on the vehicle information and the trailer information. According to a type of a service to be performed in the vehicle and the trailer, a process of selecting software for each of the vehicle and the trailer may be needed.

In addition, according to step S703, the selecting of the vehicle software and the trailer software as the response to the received vehicle information and trailer information may select software capable of performing a function requested by a customer in the vehicle and the trailer based on the vehicle information and the trailer information received at step S701.

According to step S705, the adding of the trailer data to the selected vehicle software may add the data when the server or the vehicle requests necessary data to the trailer first. Likewise, vehicle data may be added to the trailer software when the trailer requests the vehicle data as necessary.

In addition, according to step S707, the transmitting of the selected vehicle software and the selected trailer software to the vehicle may transmit both the vehicle software and the trailer software from the server to the vehicle because the server may communicate directly with the vehicle but communicate with the trailer through the vehicle. Then, the vehicle may transmit the trailer software to the trailer.

FIG. 8 is a view showing an overall configuration of a server, a vehicle and a trailer.

Referring to FIG. 8, the vehicle may consist of a memory 803, a communication unit, and a control unit, and the trailer may also consist of a memory, a communication unit, and a control unit. In both the vehicle and the trailer, not only the communication unit but also each of the other components may perform transmission and reception via wired/wireless communication. However, there may be differences in a configuration of a memory and whether direct communication is possible.

First, as for the configuration of a memory, a memory 801 of the trailer is a single memory and store one piece of software. On the other hand, the memory 803 of the vehicle may be duplexed, and at least one or more pieces of software may be stored simultaneously. For example, the memory 803 of the vehicle may be duplexed and download both vehicle SW a and trailer SW a′. The trailer SW a′ may be transmitted from a vehicle controller memory to a trailer controller memory via wired/wireless communication between the vehicle and the trailer and be stored therein.

In addition, a communication unit 807 of the vehicle may perform direct communication with the server, and the vehicle may receive both selected vehicle software and selected trailer software from the server. On the other hand, a communication unit 809 of the trailer may not perform direct communication with the server and receive the selected trailer software from the server via wired/wireless communication with the vehicle. In this regard, the communication unit 809 of the trailer may not perform direct communication with the server 805, or may alternatively perform direct communication with the server 805 in the general information transmission and reception.

FIG. 9 is a view showing an internal operation process in a vehicle and a trailer.

Referring to FIG. 9, a process of forwarding software selected from a server and store in a vehicle and a trailer may be described in detail. First, the vehicle may receive the software from the server.

First of all, an internal structure of each of the vehicle and the trailer system may be divided mainly into a background and an alive part. The background may generally mean a state in which a certain process or task is activated but there is currently no direct interaction. For example, in the vehicle, if a specific software process is being performed in the background, this process is operating but may not be displayed to a driver or a passenger or have no interaction.

On the other hand, the alive part may mean a state in which a specific process or system is activated and is operating. In this state, normal operation of the process or system may be displayed, and a user may activate a corresponding function or interact therewith. For example, if a monitoring system in the vehicle is in alive state, the system may keep collecting and displaying data and provide information when a driver needs it.

First, when the vehicle receives selected software from a server 905, the vehicle may not immediately store the software in an alive part 903 but receive the software from a background 901. Thus, the software forwarded from the background of the vehicle may be transmitted to the alive part.

Next, the alive part of the vehicle may transmit the received software to a background 907 of the trailer. After transmitting the software, the alive part 903 of the vehicle may delete the software, but if the software transmitted to the trailer includes information to be used in the vehicle, the software may not be deleted but be stored as it is.

For example, after SW A, B and C are downloaded from the server and are stored in the background of the vehicle, SW A may be stored in the alive part, and SW B and C may be transmitted to the background of the trailer because they are software for the trailer. However, SW B is not used in a vehicle controller anymore and may be deleted from the alive part of the vehicle, and SW C may be software to be used in the vehicle controller after being transmitted to the background of the trailer and thus may not be deleted from the alive part of the vehicle but be stored as it is. Next, the trailer SW B and C transmitted to the background of the trailer may be stored in the alive part of the trailer.

The trailer, which receives software from the vehicle, may consist of the background 907 and the alive part 909, which is the same as the internal structure of the vehicle, and software may be first transmitted to the background of the trailer and then be forwarded and stored in the alive part.

FIG. 10 is a view showing configurations of electronic control units in a vehicle and a trailer and various functions provided by a controller.

Referring to FIG. 10, an overall electronic control unit structure of a vehicle and a trailer may be understood, and a controller may provide a service to a user through software that executes various functions.

A vehicle and a trailer may have a same overall structure including hardware, an operating system (OS), a network and a controller.

For example, hardware 1001 of the vehicle may include an engine in charge of the main movements of the vehicle, a brake system including brake pads for stopping and controlling the vehicle, a steering system for controlling a direction of the vehicle, and an airbag system for protecting passengers from collision.

In addition, an operating system (OS) 1003 of the vehicle may use a special OS to manage various functions. For example, the OS 1003 may include an internal vehicle OS for controlling internal vehicle information and an entertainment system and an autonomous driving OS for processing sensor data and managing driving in an autonomous vehicle.

A network 1003 of the vehicle may be generally used to connect various functions and exchange data. For example, the network 1003 may include an internal CAN bus that connects a system and sensors to exchange data in the vehicle. In addition, wired/wireless communication such as Bluetooth and Wi-Fi may be used to communicate with the outside of the vehicle.

The trailer may include similar components to those of the vehicle but has a different purpose and a different service environment, and thus the hardware, OS and network of the trailer will be described in detail below.

Generally, hardware 1007 of the trailer may consist of one or more axes and a plurality of wheels to bear loads and enable movement. The hardware 1007 may be equipped with an electric system such as a running light, a brake light and a signal light.

In addition, an OS 1009 of the trailer may be mostly a simple system that a driver controls personally or forwards information in communication with the vehicle. Recently, some high-end trailers may use a dedicated software or control system for managing a specific function.

In addition, a network 1011 of the trailer may be configured more simply than the network 1005 of the vehicle, and when being connected to the vehicle, the network 1011 may mainly transmit sensor data of the trailer to the monitoring system of the running vehicle to enable a drive to understand a current situation. For example, latest trailers may include a GPS detecting function or a communication function and track a transport route or transmit information in real time.

Generally, an electronic control unit structure of a vehicle or a trailer may be a structure showing how various electronic control units in the vehicle or the trailer are connected and communicate with each other. Various software stored in a controller perform specific functions respectively and may operate by being connected via a network, a vehicle and a trailer may also be connected via wired/wireless communication.

For example, in a vehicle controller, software for performing a function of controlling the trailer, software for providing vehicle data, and software capable of interworking with a user's smartphone may be stored and provide a service (1013). A trailer controller may store software for performing a power function, a braking function, a chassis function, and a lamp function, software for performing a package monitoring service, and software for providing a trailer state and provide a service (1015).

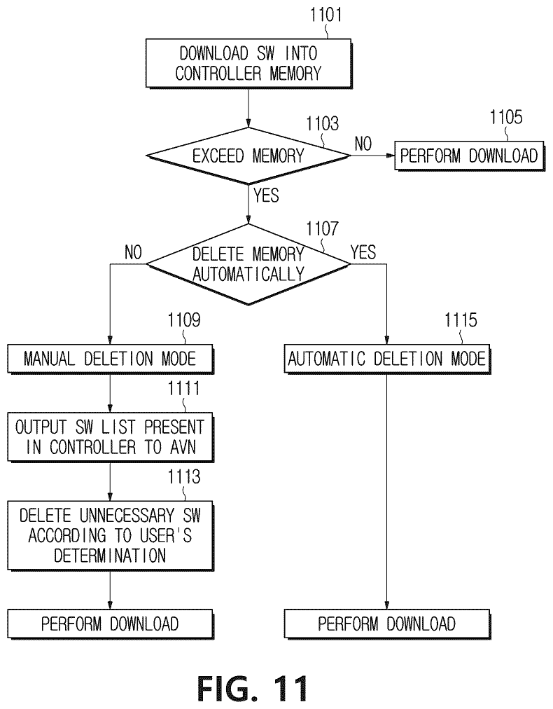

FIG. 11 is a flowchart showing a process of deleting software operating in memories of a vehicle controller and a trailer controller.

Referring to FIG. 11, the vehicle controller and the trailer controller may receive another piece of software in a memory depending on whether the memory is exceeded or may delete software, which has been received and stored, from the memory. The above deletion process may be performed in each of the vehicle controller and the trailer controller.

First, when the vehicle controller and the trailer controller download software (1101), in order to optimize a memory capacity of each of the controllers, it may be determined whether a preset memory capacity value is exceeded (1103). If the preset memory capacity value is not exceeded, the download of software capable of performing a different service may be performed (1105). On the other hand, if the preset memory capacity value is exceeded, memory deletion may be performed (1107).

A process of deleting a memory from the vehicle controller and the trailer controller may consist of an automatic deletion mode and a manual deletion mode.

In the manual deletion mode (1109), a controller may first output a currently stored software list to an audio video navigation (AVN) (1111). Based on the output software list, a user may determine and select unnecessary software and put an order of deletion. The vehicle controller and the trailer controller may delete software according to the user's order of deletion (1113).

Next, in the automatic deletion mode (1115), the vehicle controller and the trailer controller may delete software in at least one of the following conditions: the software is developed at least by a third party and its period (e.g., validity period) will expires soon (within a threshold time duration), the software is developed in a third space and has never been used (e.g., by the trailer), and the software is monitoring information related to a state (e.g., a status) of the vehicle and the trailer.

In the first and second conditions, the third party or the third space may mean an outside developer or organization in software development. That is, they may mean an outside developer or organization that is not a developing subject of main software or system, and they may be a person or an organization that provides the software or system to users.

For example, when vehicle software is developed, if an additional function is needed apart from a basic function provided in a vehicle, software or library for providing the function may be provided by a third party.

When the preset memory capacity value is not exceeded after the vehicle and the trailer execute the normal deletion mode or the automatic deletion mode, the vehicle and the trailer may receive and download software for a new function again.

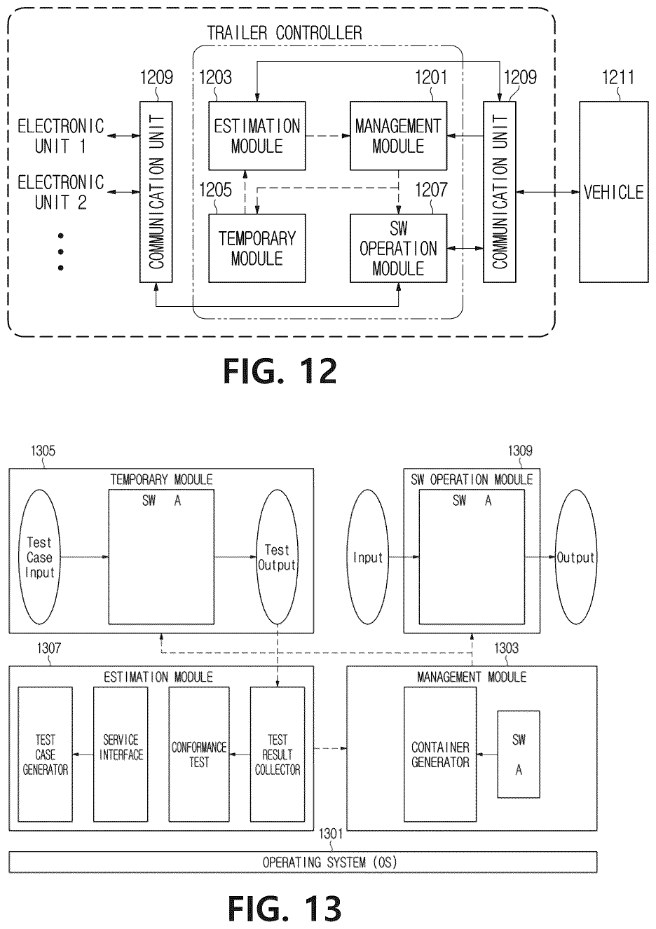

FIG. 12 is a view showing an internal structure of a trailer controller performing a software test.

FIG. 13 is a view showing a detailed process of operating a software test by internal modules of a trailer controller.

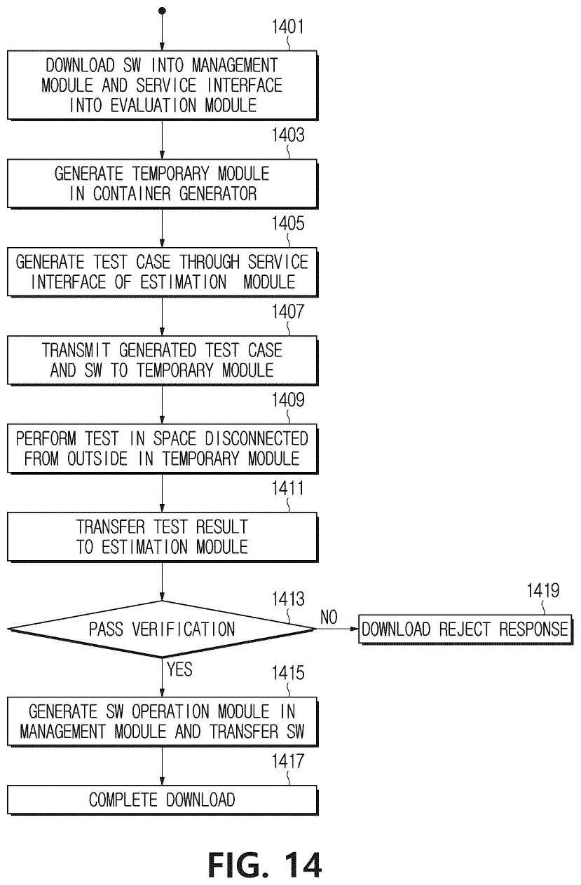

FIG. 14 is a flowchart showing a process of a software test performed in a trailer controller.

Referring to FIG. 12 to FIG. 14, a software test process, which is a criterion for determining whether to download and store software in a memory of a trailer controller, will be described in detail.

Referring to FIG. 12 and FIG. 13, the internal structures of a trailer controller and a trailer, which perform a software test, and operation processes may be known.

First, modules inside the trailer controller may perform the software test. The modules may be at least a management module 1201, an evaluation module 1203, a temporary module 1205, and a software operation module 1207. However, the modules may not perform communication directly with a server and peripheral electronic units, but the communication unit 1209 may communicate with the server 1211 and the peripheral electronic units. However, the communication unit of the trailer does not communicate directly with the server but may perform indirect communication with the server via wired/wireless communication with a vehicle.

In addition, the trailer controller may use an OS 1301, and a real-time operation system (RTOS) is normally used. The OS may be used in a system for which real-time control and reactivity are essential.

The management module 1201 may be a module in the trailer controller, which performs overall operation and management of a system. When the software test is performed in the trailer controller, the management module 1201 may set up a container generator for generating a temporary module through software received from the vehicle 1211. The evaluation module 1203 may be a module that analyzes data collected from the trailer controller, calculates various evaluation indexes and evaluates accordingly. The temporary module 1205 may mean a module for a temporarily necessary function or processing. For example, the temporary module 1205 may include a module that temporarily generates and collects data for a specific task or test and detects and processes a specific event. The software operation module 1207 may mean a module that operates software for performing various functions implemented in the trailer controller.

When the communication unit of the trailer receives software and a service interface from a server through the vehicle, the software may be transmitted to the management module 1303, and the service interface may be transmitted to the evaluation module 1307. Then, if the software test is performed in the trailer controller, the management module 1303 may set up a container generator for generating the temporary module 1305 through software received from the vehicle. For example, the container generator may mean a tool or a system capable of automatically setting a necessary environment for providing a specific function or service in a software development environment.

The evaluation module 1307 may generate a test case based on the service interface transmitted from the vehicle. The test case may be transmitted to the temporary module 1305, and the temporary module 1305 may perform the software test based on the test case transmitted from the evaluation module 1307 while being disconnected from the outside. The evaluation module may receive a test result in a test result collector from the temporary module. The evaluation module may perform a conformance test through the test result received in the test result collector. The conformance test may mean determining, based on the test case made through the test case generator, whether the trailer software operates normally.

In addition, after the software test, the management module 1303 may generate a software operation module 1309 and forward software. The software operation module 1309 may interact with at least one or more electronic units inside the trailer through the communication unit of the trailer. For example, the software received from the management module may be transmitted to the electronic units through the communication unit. Unlike the temporary module that performs a test only by being disconnected from the outside, the software operation module 1309 may receive software as an input and output a result to the outside.

Hereinafter, referring to FIG. 14, the above-described operation of the trailer controller in FIG. 12 and FIG. 13 may be additionally described through a flowchart below. That is, depending on a result of a software test performed in the trailer controller, the same software as deleted from the trailer controller may be deleted from a vehicle controller.

First, in order to perform the software test, the management module of the trailer controller may download software, and the evaluation module may receive a service interface through the vehicle (1401).

Next, the container generator in the management module may generate a temporary module (1403), and a test case may be generated through the service interface of the evaluation module (1405). For example, the test case may be a criterion for determining whether to delete a same software area that is stored in a duplexed memory of the vehicle controller and is the same as in the trailer controller. That is, the generated test case may determine whether to delete the software by determining whether the trailer software operates normally.

In addition, the generated test case and the received software may be transmitted to the temporary module (1407). The temporary module may perform a software test in its own space disconnected from the outside (1409). A test result may be forwarded to the evaluation module (1411), and it may be determined whether the software passes verification (1413). If the software passes the verification by its normal operation based on the generated test case, the management module may generate a software operation module and forward the software (1415). The trailer software may be completely downloaded in the trailer controller (1417), and a complete message may be transmitted to the vehicle controller.

On the other hand, if the software fails the verification, the trailer controller may transmit a response for rejecting the download of the trailer software (1419). Herein, the download rejection response may correspond to deleting the downloaded software or forwarding the message to a user.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

According to the present disclosure, a method is provided for sharing services between a vehicle and a trailer. The method may comprise: connecting to the trailer for communication; obtaining trailer information from the trailer; transmitting vehicle information and the obtained trailer information to a server; receiving, as a response to the transmitted vehicle information and the transmitted trailer information, selected vehicle software and selected trailer software from the server; and transmitting the trailer software to the trailer.

The method may further comprise: after the transmitting of the trailer software to the trailer, receiving a result of a trailer software test performed in the trailer; and deleting, based on the result of the test, the trailer software.

The deleting of the trailer software may comprise a manual deletion mode and an automatic deletion mode.

The method may further comprise: in the manual deletion mode, outputting a stored software list to an audio video navigation (AVN); and deleting software according to a user's deletion order.

In the automatic deletion mode, the software may be deleted according to at least one of whether the software is developed at least by a third party and its period expires soon, whether the software is developed by a third party and has never been used, and whether the software is monitoring information related to a vehicle and trailer state.

According to the present disclosure, a method is provided for sharing services between a vehicle and a trailer which is performed by the trailer. The method may comprise: connecting to the vehicle for communication; transmitting trailer information to the vehicle; and receiving trailer software from the vehicle, wherein the received trailer software corresponds to trailer software selected by the server based on vehicle information transmitted by the vehicle to the server and the trailer information.

The method may further comprise: after the receiving of the trailer software from the vehicle, performing a software test for the received trailer software; and transmitting a result of the software test for the trailer software to a vehicle controller.

The performing of the software test for the received trailer software may use a test case generated through a software service interface transmitted from the server and further comprises determining whether the received trailer software operates normally in comparison with the test case.

The method may further comprise deleting, based on the result of the test, the trailer software, wherein the deleting of the trailer software comprises a manual deletion mode and an automatic deletion mode.

The method may further comprise: in the manual deletion mode, outputting a stored software list to an audio video navigation (AVN); and deleting software according to a user's deletion order.

In the automatic deletion mode, the software may be deleted according to at least one of whether the software is developed at least by a third party and its period expires soon, whether the software is developed by a third party and has never been used, and whether the software is monitoring information related to a vehicle and trailer state.

According to the present disclosure, a method is provided for sharing services between a vehicle and a trailer which is performed by the server. The method may comprise: receiving vehicle information from the vehicle and trailer information obtained from the trailer; selecting vehicle software and trailer software based on the vehicle information and the trailer information; and adding trailer data to the selected vehicle software; and transmitting the selected vehicle software and the selected trailer software to the vehicle.

The method may further comprise transmitting a software service interface for a trailer software test that is performed in the trailer.

According to the present disclosure, a vehicle is provided sharing a service with a trailer, the vehicle. The vehicle may comprise: a memory configured to store at least one piece of software and an instruction; and a vehicle controller configured to perform wired and wireless communication with a server and the trailer and execute the at least one piece of software stored in the memory, wherein the vehicle controller is further configured to: according to the instruction, connect to a trailer controller for communication, obtain trailer information from the trailer controller, transmit vehicle information and the obtained trailer information to the server, receive, as a response to the transmitted vehicle information and the transmitted trailer information, selected vehicle software and selected trailer software from the server, and transmit the trailer software to the trailer controller.

The vehicle controller may be further configured to: after transmitting the trailer software to the trailer controller, transmit a result of a trailer software test performed in the trailer controller, and delete, based on the result, the trailer software.

The vehicle controller may be further configured to include a manual deletion mode and an automatic deletion mode, when deleting the trailer software.

In the manual deletion mode, a stored software list may be output to an audio video navigation (AVN), and software is deleted according to a user's deletion order.

In the automatic deletion mode, the software may be deleted according to at least one of whether the software is developed at least by a third party and its period expires soon, whether the software is developed by a third party and has never been used, and whether the software is monitoring information related to a vehicle and trailer state.

According to the present disclosure, a trailer is provided sharing a service between a vehicle, the trailer. The trailer may comprise: a memory configured to store at least one piece of software and an instruction; and a trailer controller configured to perform wired and wireless communication with a server and the vehicle and execute the at least one piece of software stored in the memory, wherein the trailer controller is further configured to: according to the instruction, connect to a vehicle controller for communication, transmit trailer information to the vehicle controller, receive, as a response to the transmitted trailer information, vehicle software and trailer software, which are selected by server, from the vehicle controller, and receive the trailer software from the vehicle controller.

According to the present disclosure, a server may be provided sharing a service between a vehicle, a trailer. The server may comprise: a memory configured to store software capable of providing at least one or more services; and wherein the memory includes a processor configured to execute at least one or more services, and wherein the processor is further configured to: receive vehicle information and trailer information obtained from a trailer controller from a vehicle controller, select vehicle software and trailer software as a response to the received vehicle information and the received trailer information, add trailer data to the selected vehicle software, and transmit the selected vehicle software and the selected trailer software to the vehicle controller.

The features of the present disclosure, which are briefly summarized herein, are only examples of aspects of features of the present disclosure and detailed description of the disclosure which follows and are not intended to limit the scope of the present disclosure.

According to the present disclosure, it is possible to provide a method and device for sharing a service between a vehicle and a trailer by receiving software selected from a server through wired or wireless communication between an integrated controller in the vehicle and an integrated controller in the trailer.

According to the present disclosure, it is possible to provide a method and device for adapting and modifying functions of a vehicle and a trailer through download of software with no need to adapt the vehicle or the trailer to a situation in order to efficiently perform a function according to various customers' demands.

According to the present disclosure, it is possible to provide a method and device for connecting one vehicle and a plurality of trailers at different times by transmitting selected vehicle software and trailer software by a server even when different purposes are demanded for the vehicle and each of the trailers.

According to the present disclosure, it is possible to provide a method and device for deleting downloaded software in a memory of each integrated controller to optimally manage a memory capacity of each of an integrated controller in a vehicle and an integrated controller in a trailer.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method for sharing a service between a vehicle and a trailer, which is performed by the vehicle, the method comprising:
connecting to the trailer for communication;
obtaining trailer information from the trailer;
transmitting vehicle information and the obtained trailer information to a server;
receiving, as a response to the transmitted vehicle information and the transmitted trailer information, selected vehicle software and selected trailer software from the server; and
transmitting the trailer software to the trailer.

2. The method of claim 1, further comprising:
after the transmitting of the trailer software to the trailer, receiving a result of a trailer software test performed in the trailer; and
deleting, based on the result of the trailer software test, the trailer software.

3. The method of claim 2, wherein the deleting of the trailer software comprises:
deleting the trailer software in one of a manual deletion mode or an automatic deletion mode.

4. The method of claim 3, further comprising:
in the manual deletion mode, outputting, via an audio video navigation (AVN), a stored software list; and
deleting the trailer software according to a user input indicating an order of deletion.

5. The method of claim 3, further comprising: in the automatic deletion mode, deleting the trailer software based on at least one of:
whether the trailer software is developed at least by an unverified entity,
whether a validity period of the trailer software expires within a threshold time duration,
whether the trailer software has never been used by the trailer, or
whether the trailer software is monitoring a status of the vehicle and the trailer.

6. A method for sharing a service between a vehicle and a trailer, which is performed by trailer, the method comprising:
connecting to the vehicle for communication;
transmitting trailer information to the vehicle; and
receiving trailer software from the vehicle,
wherein the received trailer software corresponds to trailer software selected by a server based on vehicle information transmitted by the vehicle to the server and the trailer information.

7. The method of claim 6, further comprising:
after the receiving of the trailer software from the vehicle, performing a software test for the trailer software; and
transmitting, to a vehicle controller of the vehicle, a result of the software test.

8. The method of claim 7, wherein the performing of the software test comprises:
determining whether the trailer software operates normally by comparing the trailer software with a test case generated through a software service interface, wherein the software service interface is transmitted from the server.

9. The method of claim 8, further comprising:
deleting, based on the result of the software test, the trailer software in one of a manual deletion mode or an automatic deletion mode.

10. The method of claim 9, further comprising:
in the manual deletion mode, outputting, via an audio video navigation (AVN), a stored software list; and
deleting the trailer software according to a user input indicating an order of deletion.

11. The method of claim 9, further comprising: in the automatic deletion mode, deleting the trailer software based on at least one of:
whether the trailer software is developed at least by an unverified entity,
whether a validity period of the trailer software expires within a threshold time duration,
whether the trailer software has never been used by the trailer, or
whether the trailer software is monitoring a status of the vehicle and the trailer.

12. A method for sharing a service between a vehicle and a trailer, which is performed by a server, the method comprising:
receiving vehicle information from the vehicle and trailer information obtained from the trailer;
selecting vehicle software and trailer software based on the vehicle information and the trailer information;
adding trailer data to the selected vehicle software; and
transmitting the selected vehicle software and the selected trailer software to the vehicle.

13. The method of claim 12, further comprising transmitting a software service interface for a trailer software test, wherein the trailer software test is configured to be performed in the trailer.

14. A vehicle capable of sharing a service with a trailer, the vehicle comprising:
memory configured to store at least one piece of software and instructions; and
a vehicle controller configured to perform communication with a server and the trailer, and execute the at least one piece of software stored in the memory,
wherein the vehicle controller is further configured to perform the method of claim 1.

15. The vehicle of claim 14, wherein the vehicle controller is further configured to:
after transmitting the trailer software to a trailer controller of the trailer, receive a result of a trailer software test performed in the trailer controller, and
delete, based on the result, the trailer software.

16. The vehicle of claim 15, wherein the vehicle controller is configured to delete of the trailer software by:
deleting the trailer software in one of a manual deletion mode or an automatic deletion mode.

17. The vehicle of claim 16, wherein the vehicle controller is further configured to:
in the manual deletion mode, output, via an audio video navigation (AVN), a stored software list; and
delete the trailer software according to a user input indicating an order of deletion.

18. The vehicle of claim 16, wherein the vehicle controller is further configured to:
in the automatic deletion mode, delete the trailer software based on at least one of:
whether the trailer software is developed at least by an unverified entity,
whether a validity period of the trailer software expires within a threshold time duration,
whether the trailer software has never been used by the trailer, or
whether the software is monitoring a status of the vehicle and the trailer.

19. A trailer capable of sharing a service with a vehicle, the trailer comprising:
memory configured to store at least one piece of software and instructions; and
a trailer controller configured to perform communication with a server and the vehicle, and execute the at least one piece of software stored in the memory,
wherein the trailer controller is further configured to perform the method of claim 6.

20. A server for sharing a service between a vehicle and a trailer, the server comprising:
memory configured to store:
instructions, and
software capable of providing at least one or more services; and
a processor configured to perform the method of claim 12
